(19) United States
(12) Patent Application Publication
(10) Pub. No.: US 2009/0093271 A1
(43) Pub. Date: Apr. 9, 2009

(54) Access To Contact Connectors Of A Mobile Terminal From Another Mobile Terminal

(75) Inventors: Christophe Martin, Cassis (FR); Frederic Faure, Cassis (FR)

Correspondence Address: BUCHANAN, INGERSOLL & ROONEY PC, POST OFFICE BOX 1404, ALEXANDRIA, VA, 22313-1404, US

(73) Assignee: Gemplus, Gemenos (FR)

(21) Appl. No.: 11/920,733

(22) PCT Filed: Apr. 28, 2006
(86) PCT No.: PCT/EP2006/061930

§ 371 Date: Nov. 20, 2007

(30) Foreign Application Priority Data
May 20, 2005 (FR) 0551310

(51) Int. Cl. H04M 1/00

(52) U.S. Cl. 455/558

(57) ABSTRACT

A smart card is initially connected to a first mobile terminal and includes a first directory file adapted to store first contact cards. To access the first contact cards, initially stored in a directory of the first terminal, from a second mobile terminal an application in the first terminal copies each of the first cards of the directory in the first directory file, if the latter does not include the first card. In the second terminal connected to the card withdrawn from the first terminal, the application copies each of the first cards of the first directory file in the file of the second terminal, if the latter does not include the first card and if the first directory file is inaccessible by the second terminal.

The present invention relates to a method of accessing contact sheets initially stored in a first mobile terminal from a second mobile terminal. More particularly, it relates to recovering contact sheets on changing mobile terminal.

Currently, in order to recover the contact sheets from a mobile terminal when replacing it, a backup service is proposed by the operator to which the mobile terminal is attached. The contact sheets are transmitted and stored in a server of the operator, and then forwarded from the server to a new mobile terminal. For this backup service, the operator has at least one server relating to mobile terminals, and in general a plurality of servers relating to respective ones of types of mobile terminal.

Another solution consists in using software on a computer to copy the contact sheets of the mobile terminal into a memory of said computer. By means of said software, the contact sheets are then copied into a memory of a new mobile terminal. Such copies can be made at a point of sale relating to the mobile terminal, or directly by the user of the mobile terminal who has acquired the software. Unfortunately, the software is specific to the make and/or to the type of the mobile terminal, which limits its use.

An object of the invention is, inexpensively and rapidly, to facilitate preservation of contact sheets when replacing a first mobile terminal with a second mobile terminal.

To achieve this object, a method of accessing first contact sheets initially stored in a phonebook of a first mobile terminal from a second mobile terminal, a smart card being initially connected to the first mobile terminal and including a first phonebook file adapted to storing first contact sheets, is characterized in that it comprises the following steps:

while the first mobile terminal is being used with the smart card, copying each of the first contact sheets from the phonebook into the first phonebook file, if said phonebook file does not contain said first contact sheet; and

while the second mobile terminal is being used with the smart card, copying each of the first contact sheets from the first phonebook file into a phonebook of the second mobile terminal, if said phonebook does not include said first contact sheet and if the first phonebook file cannot be accessed by the second mobile terminal.

It is thus easy and quick for the user to access the contact sheets of the first mobile terminal from the second mobile terminal, without using a connection to a server or using software for backing up the contact sheets, with the user merely having the smart card and the mobile terminal.

In addition, it is not necessary for the operator, to which the mobile terminal is attached, to have specific servers for backing up contact sheets of different mobile terminals. Furthermore, the operator no longer needs to train staff at points of sale in performing operations for transferring contact sheets.

According to other characteristics of the invention, the method may further comprise, while the first mobile terminal is being used with the smart card, a step of transferring second contact sheets initially stored in the phonebook of the first mobile terminal into a second phonebook file of the smart card, which second phonebook file is adapted to storing second contact sheets.

If the first phonebook file of the smart card can be accessed by a phonebook interpreter in the first mobile terminal, a step is provided for deleting the first contact sheets from the phonebook.

Transferring the second contact sheets from the first mobile terminal into the smart card, and deleting the first contact sheets from the first mobile terminal frees up storage space in the first mobile terminal, and also prevents any duplication of first or second contact sheets that is visible to the user.

The invention also provides a terminal for accessing first contact sheets initially stored in a phonebook of the terminal, a smart card being connected to the terminal and including a first phonebook file adapted to storing first contact sheets, said terminal being characterized in that it includes:

means for copying each of the first contact sheets of the phonebook of the terminal into the first phonebook file of the smart card, if the first phonebook file does not include said first contact sheet; and

means for copying each of the first contact sheets of the first phonebook file of the smart card into the phonebook of the terminal, if the phonebook of the terminal does not include said first contact sheet and if the first phonebook file cannot be accessed by the terminal.

Finally, the invention provides a computer program suitable for being implemented in a terminal for accessing first contact sheets initially stored in a phonebook of the terminal, a smart card being connected to the terminal and including a first phonebook file adapted to storing first contact sheets. The program comprises instructions which, when the program is loaded and executed in said terminal, implement the steps of the method of the invention.

Other characteristics and advantages of the present invention appear more clearly on reading the following description of preferred embodiments and implementations of the invention, given by way of non-limiting example, and with reference to the corresponding accompanying drawings, in which:

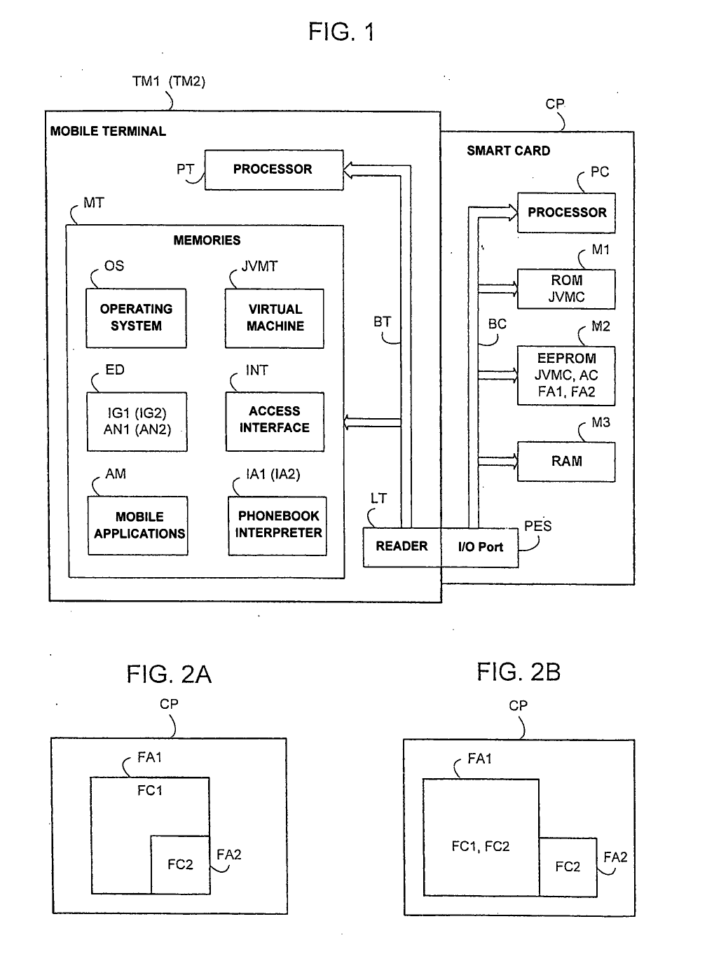

FIG. 1 is a block diagram of a mobile radio terminal and of a smart card including means of a preferred embodiment of the invention;

FIGS. 2A and 2B diagrammatically show the distribution of phonebook files in a memory of the smart card of the invention; and

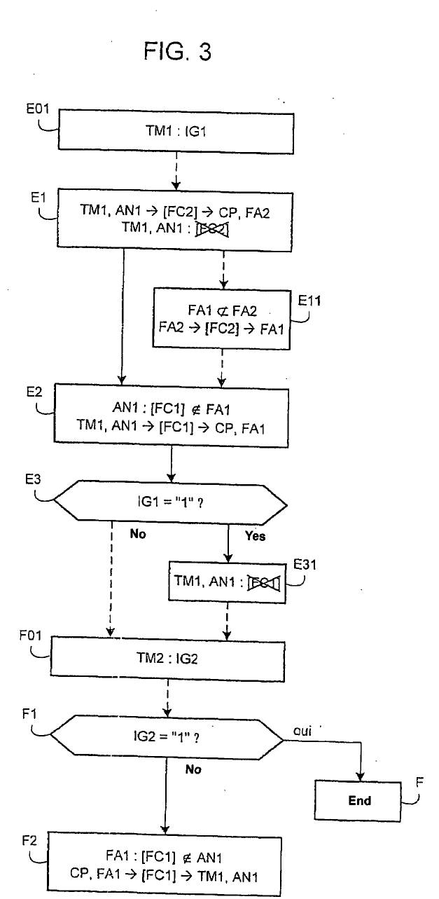

FIG. 3 is an algorithm of the steps in a method for accessing contact sheets initially stored in a first mobile terminal from a second mobile terminal, in the preferred implementation of the invention.

With reference to FIG. 1, in a mobile terminal equipped with a removable user smart card CP, most of the blocks shown perform functions related to the invention and can correspond to software and/or hardware modules.

The smart card CP is initially connected to a first mobile terminal TM1, and is then connected to a second mobile terminal TM2 replacing the first mobile terminal TM1. In the remainder of the description below with reference to FIG. 1, the term “mobile terminal” is used to designate either the first mobile terminal TM1 or the second mobile terminal TM2, and the references with the extension “1” correspond to the first mobile terminal TM1 while references with the extension “2” correspond to the second mobile terminal TM2.

The mobile terminal contains, as a peripheral, a reader LT that is connected to an input/output port PES of the smart card CP with or without electrical contact.

In addition to the smart card reader LT, the mobile terminal conventionally further comprises a processor PT and memories MT. The various elements of the terminal are connected together via a both-way bus BT. The memories MT comprise various memories such as a Read-Only Memory (ROM), a non-volatile memory of the Electrically Erasable Programmable Read-Only Memory (EEPROM) type or of the Flash Memory type, and a Random Access Memory (RAM).

The memories MT in the mobile terminal contain, in particular, an operating system (OS), e.g. of the SYMBIAN, WINDOWS MOBILE, BREW or LINUX types, an execution environment such as, for example a Java virtual machine (JVMT) programmed in the Java language, e.g. J2ME, and a data space ED for storing data such as an indicator IG1, IG2, and a phonebook AN1, AN2 listing the phone numbers to call or to consult from the mobile terminal.

In particular in the non-volatile memory of the memories MT, mobile applications AM are installed that are initially written in a high-level language of the object-oriented type such as the Java language that is compatible with the virtual machine JVMT. The virtual machine JVMT can communicate with a Java virtual machine JMVC installed in the smart card CP via a predetermined communications protocol which is typically an alternate asynchronous protocol having application protocol data units (APDUs) constituted by commands transmitted from the mobile terminal to the smart card CP and replies transmitted from the smart card CP to the mobile terminal. In this protocol, e.g. Subscriber Identity Module (SIM) Application Toolkit in the Third Generation Partnership Project (3GPP) Standard TS 51.014 or in the European Telecommunications Standards Institute (ETSI) Standard 102.223, the commands are always triggered at the initiative of the mobile terminal.

In order for the mobile applications AM to communicate with respective ones of card applications AC installed in the smart card CP in compliance with the predetermined communications protocol, an access interface INT for accessing the resources and data in the smart card is implemented in the memories MT, e.g. in the form of a Java Application Programming Interface (API) program complying with Java Specification Request (JSR) 177 when the terminal is a J2ME terminal accommodating Java technology.

The memories MT in the mobile terminal TM1, TM2 further contain a phonebook interpreter IA1, IA2 which is a user interface application accessing the contact sheets stored in the phonebook and in a memory of the smart card CP so as to present them to the user via a display of the mobile terminal.

In a variant, the mobile terminal is a small item of equipment such as a personal digital assistant (PDA) that can communicate with networks and exchange commands and replies with a smart card.

The smart card CP, also referred to as a “chip card”, as a “microcontroller card”, or as an “integrated circuit card”, constitutes a user identity module of the Universal Integrated Circuit Card (UICC) type that is removable from the mobile terminal TM. The smart card is, for example, a Universal Subscriber Identity Module (USIM) or a Removable User Identity Module (RUIM) for a Code Division Multiple Access (CDMA) network of the third generation (3GPP) of the Universal Mobile Telecommunications System (UMTS) type, or of the third generation (3GPP2) of the CDMA 2000 type.

The smart card CP conventionally comprises a processor PC, a non-rewritable memory M1 of the ROM type or of the Flash type, a non-volatile memory M2 of the EEPROM type or of the Flash type, and a memory M3 of the RAM type or of the Static RAM (SRAM) type essentially serving for exchanging commands, or requests, and replies with the mobile terminal TM through the input/output port PES and the reader LT. The various elements of the card are connected together via a two-way bus BC.

The memories M1 and M2 contain the codes and the data, for example, of an operating system and of the virtual machine JVMC in compliance with the Java Card specification, or of any other operating system. The non-volatile memory M2 contains applications, such as the USIM application, that are initially installed on manufacturing the card, and a memory space for, in particular, storing the first and second digital phonebook files FA1 and FA2 containing the phone numbers associated with various parameters such as groups to which they belong or email addresses. The memory M2 also includes a memory space for storing the card applications AC that constitute applets STK, e.g. SIM ToolKit (STK) applets, and that are installed during manufacture of the card or optionally that are installed during the use of the card at the request of the user or of the operator.

With reference to FIGS. 2A and 2B, the first phonebook file FA1 and the second phonebook file FA2 are distributed in the memory M2 of the smart card CP.

The first phonebook file FA1 is adapted to storing first digital contact sheets FC1, each of which contains at least one phone number and corresponding wording, and optionally other fields such as a group to which it belongs, or an email address, for example. The first phonebook file FA1 contains, in particular, a plurality of sub-files that are adapted to storing respective ones of said fields.

The second phonebook file FA2 is adapted to store second digital contact sheets FC2, each of which contains one phone number only and corresponding wording.

Preferably, the second phonebook file FA2 has a format adapted to storing the phone number and the corresponding wording of a first contact sheet FC1 only. In which case, the second phonebook file FA2 is considered as being included in the first phonebook file FA1, as indicated in FIG. 2A. Thus, when a user wishes to store a second contact sheet FC2 in the first phonebook file FA1, the second contact sheet FC2 is stored in the second phonebook file FA2 in a manner that is transparent for the user.

In a variant, the second phonebook file FA2 has a format that is unsuitable for storing the phone number and the corresponding name of a first contact sheet FC1. In which case, the second phonebook file FA2 is considered as being separate from the first phonebook file FA1, as indicated in FIG. 2B. Thus, when a user stores a second contact sheet FC2 in the second phonebook file FA2 from a “second-generation” first mobile terminal, and then uses a “third-generation” second mobile terminal as explained below with reference to a method step E11, a card application AC copies each second contact sheet FC2 from the second phonebook file FA2 into the first phonebook file FA1.

The mobile terminal is said to be a “second-generation” mobile terminal when the phone-book interpreter IA1, IA1 accesses only the second phonebook file FA2 of the smart card CP. However, a mobile application AM specific to the invention has access to the first phonebook file FA1.

The mobile terminal is said to be a “third-generation” mobile terminal when the phonebook interpreter accesses only the first phonebook file FA1 of the smart card CP. When the second phonebook file FA2 is included in the first phonebook file FA1, the phonebook interpreter also accesses the second phonebook file FA2 through the first phonebook file FA1. Conversely, when the second phonebook file FA2 is not included in the first phonebook file FA1, the phonebook interpreter does not access the second phonebook file FA2.

In a preferred implementation of the invention shown in FIG. 3, the method of accessing contact sheets initially stored in a first mobile terminal TM1 from a second mobile terminal TM2 comprises steps E1 to E31 while the first mobile terminal TM1 is being used with the smart card CP, and steps F1 and F2 while the second mobile terminal TM2 is being used with the smart card CP.

A user initially uses the first mobile terminal TM1 connected to the smart card CP. First and second contact sheets FC1 and FC2 have been stored during the use of the first mobile terminal TM1. The user wishes to acquire a second mobile terminal TM2 to be used with the smart card CP while also preserving the contact sheets FC1 and FC2 relating to the first mobile terminal TM1. The first and second mobile terminals TM1 and TM2 are second-generation or third-generation mobile terminals.

The mobile application AM specific to the invention is implemented in the non-volatile memory of the memories MT of the first and second mobile terminals TM1 and TM2. For example, said implementation is performed while the mobile terminals are being manufactured, or at the request of the user while the mobile terminals are being used, and it can result in a signing up for a subscription or for an additional service provided by an operator who has sold the mobile terminals TM1 and TM2.

When the access interface INT does not allow the mobile application AM direct access to the phonebook files FA1 and FA2 of the smart card CP, a card application AC that is specific to the invention is implemented in the memory M2 of the smart card CP, communicates with the mobile application AM, and allows said mobile application to read and to modify the phonebook files FA1 and FA2.

In a preliminary step E01, the mobile application AM in the first mobile terminal TM1 determines a first generation indicator IG1 which is in a first logic state “0” if the first mobile terminal is a second-generation mobile terminal, and in a second logic state “1” if the first mobile terminal is a third-generation mobile terminal. The indicator IG1 is stored in the data space ED of the first mobile terminal TM1 and can be accessed by any application used by the first mobile terminal.

In step E1, the mobile application AM specific to the invention requires a communications session to be opened between the mobile application AM and the smart card CP at the access interface INT. The mobile application AM transfers the second contact sheets FC2 stored in the phonebook AN1 from the first mobile terminal TM1 to the second phonebook file FA2 of the smart card CP. In other words, the second contact sheets FC2 are firstly copied into the second phonebook file FA2, and are then deleted from the phonebook AN1.

Since the first mobile terminal TM1 is a second-generation or a third-generation terminal, the second contact sheets FC2 are read from the smart card CP if the second phonebook file FA2 is included in the first phonebook file FA1 (FIG. 2A). If the first mobile terminal TM1 is a second-generation terminal, the phonebook interpreter IA1 accesses the second phonebook file FA2, and if the first mobile terminal TM1 is a third-generation mobile terminal, the phonebook interpreter IA1 also accesses the second phonebook file FA2 by means of the first phonebook file FA1.

If the second phonebook file FA2 is not included in the first phonebook file FA1 (FIG. 2B), the card application AC copies the second contact sheets FC2 from the second phonebook file FA2 into the first phonebook file FA1, in a step E11. In which case, if the first mobile terminal TM1 is a second-generation mobile terminal, the phonebook interpreter IA1 accesses the second phonebook file FA2 only, and the second contact sheets FC2 copied into the first phonebook file FA1 are not visible to the user. If the first mobile terminal TM1 is a third-generation mobile terminal, the phonebook interpreter IA1 accesses only the second contact sheets FC2 copied into the first phonebook file FA1.

At the end of step E1 or of step E11, regardless of whether the first mobile terminal TM1 is a second-generation or a third-generation terminal, the user reads the second contact sheets FC2 stored in the smart card CP and does not observe any duplication of the second contact sheets FC2.

In step E2, the mobile application AM detects the first contact sheets FC1 that are common to the phonebook AN1 and to the first phonebook file FA1. For any first contact sheet FC1 that is included in the phonebook AN1 and that is not included in the file FA1, the mobile application AM copies the first contact sheet FC1 stored in the phonebook AN1 into the file FA1 of the smart card CP. Conversely, any common first contact sheets FC1 are not copied. The step E2 is necessary to avoid any duplication of first contact sheets FC1 in the first phonebook file FA1.

In step E3, the mobile application AM reads the first generation indicator IG1 stored in the data space ED of the first mobile terminal TM1.

If the first generation indicator IG1 is in the first state “0” and thus if the first mobile terminal TM1 is a second-generation mobile terminal, the phonebook interpreter IA1 accesses the second phonebook file FA2 only, and the first contact sheets FC1 copied into the first phonebook file FA are not visible to the user.

If the first generation indicator IG1 is in the second state “1” and thus if the first mobile terminal TM1 is a third-generation mobile terminal, the phonebook interpreter IA1 accesses the first phonebook file FA1 and the mobile application AM deletes the first contact sheets FC1 from the phonebook AN1, in step E31. Such deletion prevents any duplication of the first contact sheets FC1 being visible to the user at the end of step E2, because those sheets will then be present and accessible both in the first mobile terminal TM1 and in the smart card CP.

In a variant, the steps E2, E3, and E31 precede the steps E1 and E11.

At the end of the step E3 or of the step E31, all of the contact sheets FC1 and FC2 initially stored in the phonebook AN1 of the first mobile terminal TM1 are stored in the smart card CP. The user then removes the smart card CP from the first mobile terminal TM1 and acquires a second mobile terminal TM2 into which the user inserts the smart card CP which is then connected to the terminal TM2.

In a manner analogous to step E01, the mobile application AM in the second mobile terminal TM2 determines a second generation indicator IG2 which is in a first logic state “0” if the second mobile terminal is a second-generation terminal and in a second logic state “1” if the second mobile terminal is a third-generation terminal, in a preliminary step F01. The second generation indicator IG2 is stored in the data space ED of the second mobile terminal TM1 and can be accessed by any application used by the second mobile terminal.

In step F1, the mobile application AM reads the indicator IG2 stored in the data space ED of the terminal TM2.

If the indicator IG2 is in the second state “1” and thus if the second mobile terminal TM2 is a third-generation mobile terminal, the phonebook interpreter IA2 accesses all of the contact sheets FC1 and FC2 stored in the smart card CP, as described above. In which case, the method ends, as indicated, at a step F, and the user can access the contact sheets initially stored in the first mobile terminal TM1 from the second mobile terminal TM2.

If the indicator IG2 is in the first state “0” and thus, if the second mobile terminal TM2 is a second-generation mobile terminal, the phonebook interpreter IA2 accesses only the second contact sheets FC2 included in the second phonebook file FA2 of the smart card CP, the first phonebook file FA1 being inaccessible. In which case, in step F2, the mobile application AM copies each of the first contact sheets FC1 included in the first phonebook file FA1 of the smart card CP into the phonebook AN2 of the second mobile terminal TM2, if the phonebook AN2 does not include said first contact sheet FC1. In a manner analogous to step E2, the mobile application checks whether the first contact sheets FC1 are present in the phonebook AN2 so as to avoid any duplication of first contact sheets FC1 in the phonebook AN2.

In a variant, the mobile application AM requests the user to validate the operation to be performed at each step of the method of the invention.

In another variant, while the first mobile terminal TM1 is being used, the steps E2, E3, and E31 are performed every time that the user stores a first contact sheet FC1 in the phonebook AN1 of the first mobile terminal TM1, and the steps E1 and E11 are performed every time the user stores a second contact sheet FC2 in the phonebook AN1 of the terminal TM1.

The invention described herein relates to a method and a terminal TM1, or TM2, for accessing first contact sheets stored in a phonebook of the terminal, a smart card being connected to the terminal and including a first phonebook file adapted to storing first contact sheets. In a preferred implementation, the steps of the method of the invention are determined by the instructions of a computer program incorporated in a terminal such as the first mobile terminal TM1 and/or the second mobile terminal TM2. The program includes program instructions which, when said program is loaded and executed in the terminal whose operation is then controlled by executing the program, implement the steps of the method of the invention.

Therefore, the invention also applies to a computer program, in particular a computer program on or in an information medium, which program is suitable for implementing the invention.

1. A method of accessing first contact sheets initially stored in a phonebook of a first mobile terminal from a second mobile terminal, a smart card being initially connected to the first mobile terminal and including a first phonebook file adapted to storing first contact sheets, said method comprising the following steps:
while the first mobile terminal is being used with the smart card, copying each of the first contact sheets from the phonebook into the first phonebook file, if said phonebook file does not contain said first contact sheet; and
while the second mobile terminal is being used with the smart card, copying each of the first contact sheets from the first phonebook file into a phonebook (AN2) of the second mobile terminal, if said phonebook does not include said first contact sheet and if the first phonebook file cannot be accessed by the second mobile terminal.

2. A method according to claim 1, further comprising, while the first mobile terminal is being used with the smart card, a step of transferring second contact sheets initially stored in the phonebook of the first mobile terminal into a second phonebook file of the smart card, which second phonebook file is adapted to storing second contact sheets.

3. A method according to claim 2, in which the second phonebook file is included in the first phonebook file.

4. A method according to claim 2, further comprising in the smart card, if the second phonebook file is not included in the first phonebook file, a step of copying the second contact sheets from the second phonebook file into the first phonebook file.

5. A method according to claim 1, further comprising, while the first mobile terminal is being used with the smart card, and after the copying step, a step of deleting the first contact sheets from the phonebook of the first mobile terminal if the first phonebook file can be accessed by the first mobile terminal.

6. A terminal for accessing first contact sheets initially stored in a phonebook of the terminal, a smart card being connected to the terminal and including a first phonebook file adapted to storing first contact sheets, said terminal being including:
means for copying each of the first contact sheets of the phonebook of the terminal into the first phonebook file of the smart card, if the first phonebook file (FA) does not include said first contact sheet; and
means for copying each of the first contact sheets of the first phonebook file of the smart card into the phonebook of the terminal, if the phonebook of the terminal does not include said first contact sheet and if the first phonebook file cannot be accessed by the terminal.

7. A computer program stored on a computer-readable medium for implementation in a terminal for accessing first contact sheets initially stored in a phonebook of the terminal, a smart card being connected to the terminal and including a first phonebook file adapted to storing first contact sheets, said program comprising instructions which, when the program is loaded and executed in said terminal, implement the following steps:
copying each of the first contact sheets from the phonebook into the first phonebook file, if said phonebook file does not contain said first contact sheet; and
copying each of the first contact sheets from the first phonebook file into the phonebook, if the phonebook does not include said first contact sheet and if the first phonebook file cannot be accessed by the terminal.

8. A method according to claim 2, further comprising, while the first mobile terminal is being used with the smart card, and after the copying step, a step of deleting the first contact sheets from the phonebook of the first mobile terminal if the first phonebook file can be accessed by the first mobile terminal.

9. A method according to claim 3, further comprising, while the first mobile terminal is being used with the smart card, and after the copying step, a step of deleting the first contact sheets from the phonebook of the first mobile terminal if the first phonebook file can be accessed by the first mobile terminal.

10. A method according to claim 4, further comprising, while the first mobile terminal is being used with the smart card, and after the copying step, a step of deleting the first contact sheets from the phonebook of the first mobile terminal if the first phonebook file can be accessed by the first mobile terminal.
